(19) United States
(12) Patent Application Publication
(10) Pub. No.: US 2018/0067785 A1
(43) Pub. Date: Mar. 8, 2018

(54) PERFORMANCE OF DATA PASTING-RELATED ACTION BASED ON CUT OR COPIED DATA ATTRIBUTE

(71) Applicant: Lenovo Enterprise Solutions (Singapore) PTE. LTD., New Tech Park (SG)

(72) Inventors: John Scott Crowe, Durham, NC (US); Gary David Cudak, Wake Forest, NC (US); Jennifer J. Lee-Baron, Morrisville, NC (US); Nathan J. Peterson, Oxford, NC (US); Amy Leigh Rose, Chapel Hill, NC (US); Bryan L. Young, Tualatin, OR (US)

(21) Appl. No.: 15/258,733

(22) Filed: Sep. 7, 2016

(51) Int. Cl. G06F 9/54; G06F 3/0482

(52) U.S. Cl. CPC G06F 9/543; G06F 3/0482

(57) ABSTRACT

A computing device detects performance of a cut/copy action of data within a user interface of the computing device. In response to detecting the performance of the cut/copy action, the computing device determines a likely destination at which pasting of the data will occur, based on an attribute of the data, and an action related to pasting of the data at the likely destination, based on the attribute of the data. The computing device performs the action.

### BACKGROUND

Cut and paste and copy and paste are user interface techniques used to transfer data between locations within the same file, or across files. The cut command or action removes selected data from its current location, whereas the copy command or action creates a duplicate of the selected data. The original or duplicated data is stored in a temporary location referred to as the clipboard. The data from the clipboard is then inserted at a selected position within another file via the paste command or action.

### SUMMARY

An example method includes detecting, by a computing device, performance of a cut/copy action of data within a user interface of the computing device. The method includes, in response to detecting the performance of the cut/copy action, determining, by the computing device, an action related to pasting of the data, based on an attribute of the dat. The method includes performing the action, by the computing device.

An example non-transitory computer-readable data storage medium stores computer-executable code. A computing device executes the code to detect performance of a cut/copy action of data within a user interface of the computing device. The computing device executes the code to, in response to detecting the performance of the cut/copy action, determine a likely destination at which pasting of the data will occur, based on an attribute of the data, and an action related to the pasting of the data at the likely destination, based on the attribute of the data. The computing device executes the code to perform the action.

An example computing device includes a processor, and a non-transitory computer-readable data storage medium storing computer-executable code. The processor executes the code to detect that a cut/copy action of data has occurred within a user interface of the computing device. The processor executes the code to, in response to detecting the performance of the cut/copy action, determine a likely destination at which pasting of the data will occur, based on an attribute of the data, and an action related to the pasting of the data at the likely destination, based on the attribute of the data. The processor executes the code to perform the action.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of an example method of an example usage scenario in which a data pasting-related action is performed based on a data attribute of cut or copied data.

FIG. 2 is a flowchart of an example method of another example usage scenario in which a data pasting-related action is performed based on a data attribute of cut or copied data.

FIG. 3 is a flowchart of an example method of a third example usage scenario in which a data pasting-related action is performed based on a data attribute of cut or copied data.

FIG. 4 is a flowchart of an example method of a fourth example usage scenario in which a data pasting-related action is performed based on a data attribute of cut or copied data.

FIG. 5 is a flowchart of an example method, encompassing the example usage scenarios of FIGS. 1-4, in which a data pasting-related action is performed based on a data attribute of cut or copied data.

FIG. 6 is a flowchart of another example method, consistent with but more detailed than that of FIG. 5, in which a data pasting-related action is performed based on a data attribute of cut or copied data.

FIG. 7 is a block diagram of a computing device in which a data pasting-related action is performed based on a data attribute of cut or copied data.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background, cut/copy and paste is a user interface technique to move data within a file or across different files. A user typically selects data at a current location of a cursor or pointer within a file and then performs a cut action to move the selected data to the clipboard, or a copy action to duplicate the selected data in the clipboard. The user then manually moves the cursor or pointer to a different location within the file, or moves the cursor or pointer to a location within a different file, and performs a paste action to copy the data from the clipboard to the new location.

Cut/copy and paste, while being a powerful user interface technique to move data within a file or between files, can be laborious in practice, however. Users may have many files open on the same or different applications, for instance. This means that after copying or cutting data from one file, the user has to navigate among a large number of other files before locating the intended file at which the data is to be pasted. Similarly, a given file, such as a word processing document, may be quite long, such that after a user cuts data from one location within the file, the user has to navigate through the document before locating the intended location at which the data is to be pasted.

These issues are exacerbated if a user has to cut or copy and paste a large number of data items. For example, the user may be assembling a list of phone numbers within a particular file. Each time the user locates and copies a phone number within a file, the user has to navigate back to the particular file to paste the copied phone number into the particular file. Repeating this process tens or even hundreds of times will require a large amount of time, a good portion of which is spent just navigating to the destination file at which data pasting is to occur after having copied the data from a source file.

Techniques disclosed herein lessen these issues, by performing a data pasting-related action based on an attribute of the data that has been cut or copied. After a user has cut or copied data, an action related to the pasting of the data is determined based on an attribute of the data. The action is then performed, either automatically, or responsive to the user performing further interaction with a user interface of the computing device that the user is operating.

As one example, each time a user cuts or copies textual data, the data may be examined to determine whether it has a structure consistent with that of a phone number. If the cut or copied data has such a data structure, the computing device may automatically navigate to the end of a particular file in which the user has been pasting phone numbers. The computing device may further automatically paste the cut or copied phone number within the file.

As another example, each time a user cuts or copies textual data, the data may be examined to determine whether it has a structure consistent with that of a part number of a manufacturer with which the user is employed. If the cut or copied data has such a data structure, the computing device may determine the open applications or the open files at which the user has previously pasted part numbers. When the user initiates a task-switching graphical user interface (GUI) component to switch among open applications or open files, the open applications or files can be displayed in an order corresponding to their likelihoods of being the user's intended destination for pasting the data in question.

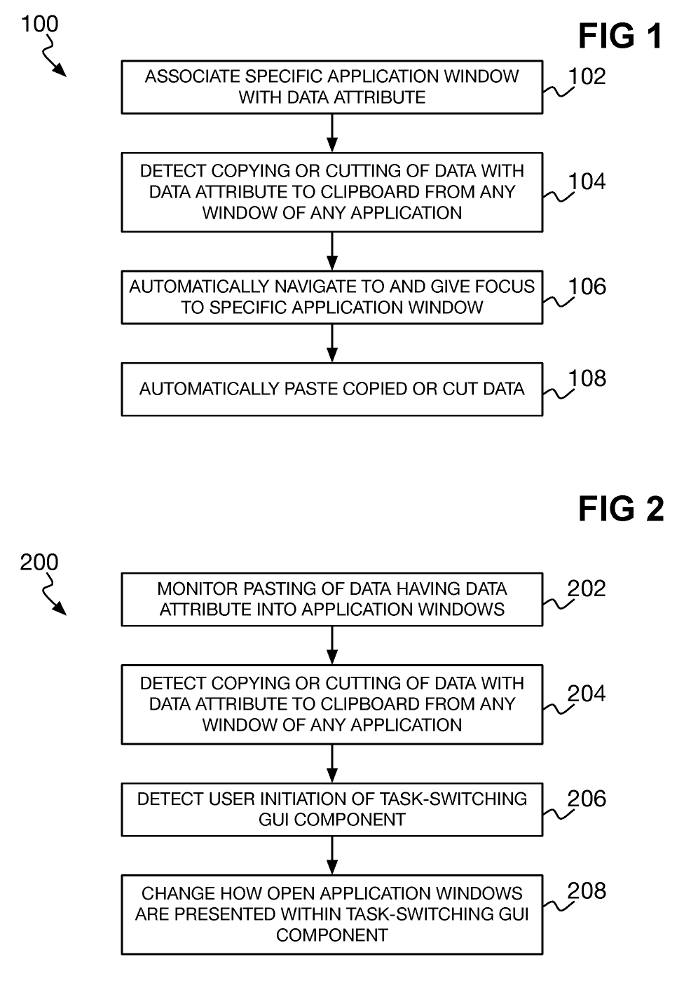

FIG. 1 shows an example method 100 of an example usage scenario of the performance of a data pasting-related action based on a data attribute of cut or copied data. The usage scenario contemplates a user using a computing device that has a GUI in which a number of different application windows are open. For instance, the user may have a word processing application program running that has many different application windows open. Each application window corresponds to a different word processing document, or file, which is open. The user may have a spreadsheet application program running that also has many different application windows open, each of which corresponds to a different spreadsheet document, or file, which is open. The user may also have a chat messaging program running that has a number of different application windows open. Each application window corresponds to a different chat session, or conversation.

A specific application window is associated with a data attribute (102). The data attribute may be a data structure or format of a phone number, such as ten digits separated by dashes as in the data format XXX-YYY-ZZZZ, or ten digits separated by a set of parentheses, a space, and a dash as in the data format (XXX) YYY-ZZZZ. The data attribute may be a data structure or format of a part number, according to the part number format utilized by a particular manufacturer. The specific application window may be a particular application window of the chat messaging program.

Association of the specific application window with a data attribute can be performed automatically, semi-automatically with user interaction but initiated by the computing device, or completely manually as initiated by the user. As an example of automatic association, when the user copies data having the data attribute, and then pastes the data into a specific application window, the specific application window may be automatically associated with the data attribute. As an example of semi-automatic association, when the user copies data having the data attribute and then pastes the data into a specific application window, a dialog box may be appear on the GUI asking the user if he or she wishes to associate the data attribute with this specific application window. As an example of manual association, the user may manually specify the data attribute, and may manually select or specify the specific application window to be associated with the data attribute.

After the specific application window has been associated with the data attribute, the computing device detects copying or cutting of data with the same data attribute to the clipboard from any application window of any application program (104). In the example where the data attribute is the data structure or format of a phone number, for instance, the user may copy “(555) 345-6789” from an open application window of a word processing program, “202-456-1414” from an open application window of a spreadsheet program, and so on. The actual data that is copied may differ, in other words, but the data that is copied is consistent with (i.e., matches or has) the same data attribute with which a specific application window was specifically associated in part 102.

In response to detecting the cutting or copying of data with the data attribute in question, the computing device automatically navigates to and gives focus to the specific application window that has been associated with this data attribute (106). Focus within the context of a GUI indicates the application window (or other GUI component) that is selected to receive input. For instance, text entered at the keyboard or pasted from the clipboard is entered at the window or other GUI component that currently has focus. In the example, therefore, one of the application windows of the chat application program that was previously associated with the data attribute receives focus. This window is further navigated to in that the window is brought to the foreground on the desktop of the GUI, so that no other window(s) are in front.

Advantageously, then, the user does not have to laboriously locate the specific application window of the chat application program on the desktop and select the window to manually provide it with focus. The user does not have to initiate a task-switching component of the GUI to switch from the current application window from which the data was cut or copied to the specific application window of the chat application program. Rather, once the user has cut or copied data that has the data attribute in question, the computing device automatically switches focus from the current application window to the specific application window of the chat application program.

Furthermore, the computing device may automatically paste the copied or cut data into the specific application window that now has focus and is in the foreground (108). For example, the data may be pasted (i.e., inserted) at the bottom of the window, or at the end of the document or data that has already been entered in the window. When automatic pasting occurs, the user not only does not have to manually navigate to the specific application window associated with the data attribute of the data that has been cut or copied, the user also does not have to even paste the data into this window using a pointing device like a mouse, or a keyboard shortcut on the keyboard. In the example of FIG. 1, parts 106 and 108 constitute the data pasting-related action that is performed based on the data attribute of cut or copied data.

FIG. 2 shows an example method 200 of another example usage scenario of the performance of a data pasting-related action based on a data attribute of cut or copied data. The usage scenario again contemplates a user using a computing device that has a GUI in which a number of different application windows are open. For instance, the user may have three application programs open, numbered one through three. Each application program may itself have three documents or files—i.e., application windows—open, which are also numbered one through three.

The computing device monitors pasting of different data having the same data attribute that have been cut or copied to the clipboard into application windows (202). For instance, as the user manually copies or cuts phone number data to the clipboard, the computing device monitors into which application window(s) the user then pastes the data. The user may primarily paste phone number data into application window 2 of application program 1. The user may also, in decreasing order of frequency, paste manually phone number data into application window 3 of application program 3, application window 1 of application program 2, and application window 3 of application program 1. The user may not paste any phone number data into the other application windows of these three application programs.

The computing device thus detects copying or cutting of data with this same data attribute (e.g., having a data format consistent with that of a phone number) to the clipboard from any application window of any application program (204). The computing device then detects user initiation of a task-switching GUI component (206), which may be in the form of a touch gesture or a keyboard shortcut. The computing device may detect the user initiation of the task-switching GUI component just if the user initiation was the next interaction the user has with the GUI of the computing device after having cut or copied the data into the clipboard. As such, if the user performs a different interaction with the GUI after he or she has cut or copied data to the clipboard, the method 200 in this case ends and parts 206 and 208 are not performed. In another implementation, the user detects user initiation of the task-switching GUI component at any time after the user has cut or copied data into the clipboard, even if one or more other user-GUI interactions occur between the cutting or copying of data and the initiation of the task-switching GUI component.

The computing device, in response to detecting user initiation of the task-switching GUI component, changes how open application windows are presented within the task-switching GUI component (208). In general, the task-switching GUI component is that which permits switching among open application windows using a keyboard shortcut or a touch gesture. Normally, this GUI component depicts all open application windows, or in some operating systems, all open application programs. The order in which the open application windows or application programs is usually depicted in a descending recency of use order. Therefore, the open application window or program that most recently had focus prior to the window or program that currently has focus is displayed first, followed by the open window or program that second most recently had focus, and so on.

The computing device can change how the open application windows are presented within the task-switching GUI component in a number of different ways. For example, the computing device may suppress display of any open application window (or any open application program if individual application windows are not depicted) into which the user has not ever pasted data having the data attribute of the data that the user has most recently copied or cut to the clipboard. Therefore, in the example, application windows other than application window 2 of application program 1, application window 3 of application program 3, application window 1 of application program 2, and application window 2 of application program 1 may not be displayed within the task-switching GUI, even though they are indeed open application windows.

As another example, the computing device may also or instead order the open application windows in the order of frequency in which the user has pasted data having the data attribute of the data most recently copied or cut to the clipboard. Therefore, in the example, the application windows may be ordered so that application window 2 of application program 1 is listed first, followed by application window 3 of application program 3, followed by application window 1 of application program 2, and followed by application window 2 of application program 1, within the task-switching GUI. The other application windows may not be displayed, or may be displayed in a descending recency of use order. Thus, application window 2 of application program 1 is listed first, even though it may not be the application window that most recently had focus prior to the open application window that currently has focus.

In the example usage scenario of FIG. 2, the data pasting-related action that is performed includes changing how the open application windows (or open applications) are presented within the task-switching GUI component. Advantageously, the user is thus more likely to quickly navigate to the desired application window (or application) at which he or she wishes to paste the copied or cut data, based on the windows or applications the user has previously pasted data having the same attribute. This is likely the case even if the desired application window or application has not been used recently, such that it would normally be located closer to or at the end of the list of open application windows or applications, instead of closer to or at the front of the list.

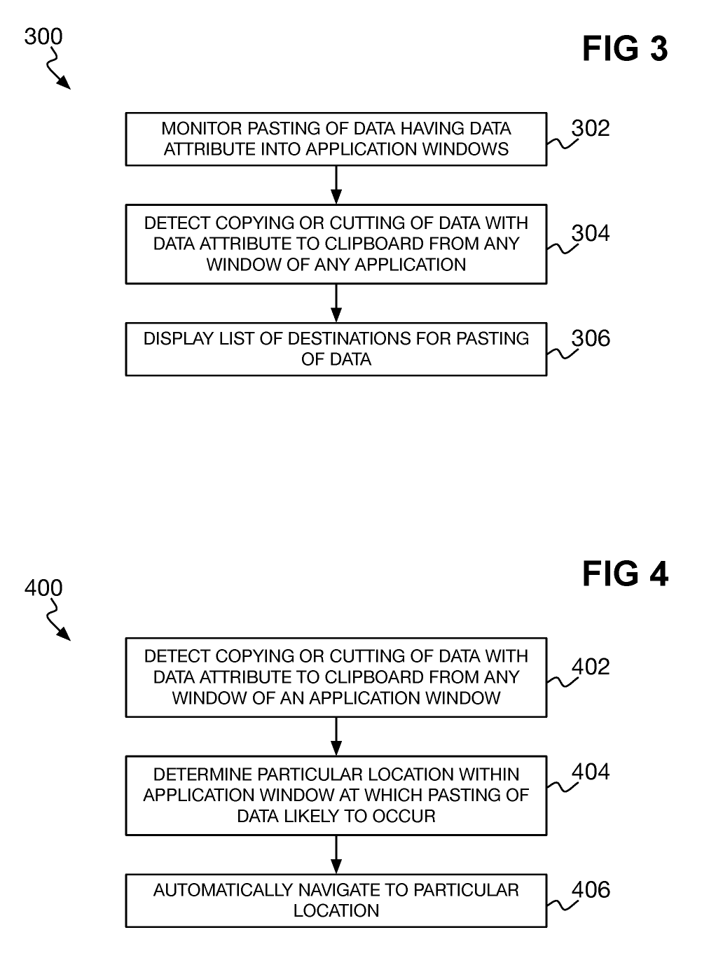

FIG. 3 shows an example method 300 of a third example usage scenario of the performance of a data pasting-related action based on a data attribute of cut or copied data. The usage scenario contemplates a user using a computing device that has a GUI in which a number of different application windows are open, where each application window corresponds to a different file or document. There may further be a number of other files or documents that are not currently open—that is, which do not have corresponding open application windows.

The computing device monitors pasting of different data having the same data attribute that have been cut or copied to the clipboard into application windows (302), as has been described above in relation to part 202 of FIG. 2. Furthermore, after data has been pasted to any such application window, the user may subsequently close the window. As such, the file or document that was open within the application window is no longer currently editable and is thus also considered as not being currently open.

The computing device detects copying or cutting of data with this same attribute—in one example, having a data format consistent with that of a phone number, for instance—to the clipboard from any application window of any application program (304). In response, the computing device displays a list of likely destinations for pasting of the data (306). The computing device may automatically display this list responsive to the user copying or cutting of data with the data attribute in question, or may display the list in response to the user performing a further user interface interaction, such as by selecting a corresponding GUI element, entering a keyboard shortcut on the keyboard, and so on.

The list of likely destinations can include files or documents that are currently open, as well as those that are no longer currently open. That is, the list of likely destinations can include files that are open in currently open application windows, as well as files that are no longer open in application windows. The destinations can be ordered in the list according to the number of times the user has pasted data having the same data attribute in each destination. For example, a file in which the user has pasted phone number data fifteen times is listed higher in the list than a file in which the user has pasted phone number data ten times. Files in which the user has not pasted any phone number data may not be listed in the list of likely destination.

If the user selects a destination that is a file that is open in a currently open application window, the computing device can bring that window to the foreground and give it focus. If the user selects a destination that is a file that is not currently open, the computing device can cause that file to be opened. That is, if the application program in which the file is to be opened is not running, then the computing device launches the program and causes the program to open the file. If the application program is already running, then the computing device causes the program to open the file. In either cause, the file may be opened in a new application window of the application program.

In the example usage scenario of FIG. 3, the data pasting-related action that is performed includes displaying the list of likely destinations for pasting of the cut or copied data, permitting the user to select a desired destination, and opening the selected file if not already open and even if already open giving the application window corresponding to the file in question focus. Advantageously, the user is more likely to be able to select the desired destination for pasting the cut or copied data. This is particularly the case if the desired destination is a file that is no longer open. Rather than having to locate the file on a storage device via a GUI component and manually open the file, the user simply has to select the file from the list.

FIG. 4 shows an example method 400 of a fourth example usage scenario of the performance of a data pasting-related action based on a data attribute of cut or copied data. The usage scenario of FIG. 4 contemplates a user using a computing device that has a GUI in which an application window of an application program is open. For example, the application window may correspond to a word processing document, or a spreadsheet document.

The computing device detects copying or cutting of data having a data attribute to a clipboard from the application window (402). The user copies or cuts the data from a location within the file or document. For example, a word processing document has a beginning or end, between which there is text. A user cuts or copies one or more characters from within the existing text of the document. As another example, a spreadsheet document has a number of cells, organized in a grid of rows and columns. A user cuts or copies a cell identifiable by a row and a column.

The computing device determines a particular location within the same application window at which pasting of the data is likely to occur (404). For example, the user may have previously pasted phone number at the end of a word processing document, or at the next available cell within a particular row or column of a spreadsheet document. Therefore, the particular location within the same application window may be the end of the word processing document, or the next available cell within the particular row or column of the spreadsheet.

As such, the computing device automatically navigates to this particular location within the same open application window (406). In one implementation, the computing device may automatically paste the cut or copied data at this location. In the example usage scenario of FIG. 3, then, the data pasting-related action that is performed includes automatic navigation to a location at which pasting of the cut or copied data is likely to occur, and can include the automatic pasting of the data at this location.

Advantageously, the user does not have to navigate to this location within the open file or document him or herself. This is especially helpful where, for instance, the user is assembling at the end of a word processing document a list of all the phone numbers mentioned elsewhere in the document, for example. The user does not have to continually navigate to the location at which he or she is assembling the list. Rather, once the user copies the data, the computing device navigates to the location. In one implementation, as has been described, such navigation occurs automatically, as soon as the user has cut or copied the data. In another implementation, however, the user may initiate the navigation by pressing a keyboard shortcut or initiating a command in another manner, or by affirming such navigation if the computing device presents a dialog box or other GUI component asking if the user wishes to navigate to the location in question.

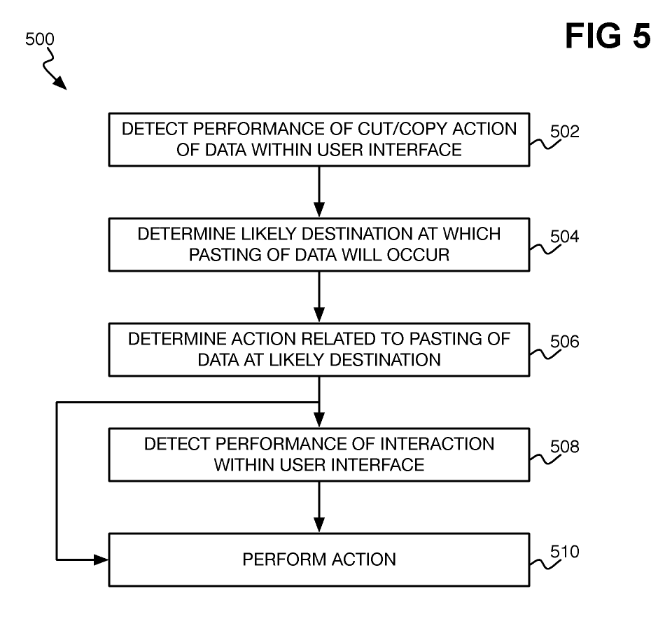

FIG. 5 shows an example method 500 in which a data pasting-related action is performed based on a data attribute of cut or copied data. The method 500 encompasses the example usage scenarios that have been described in relation to FIGS. 1-4. A computing device performs the method 500.

The computing device detects performance of a cut/copy action within a user interface of the computing device (502), such as a GUI. A cut/copy action as defined herein is either performance of a cut command or performance of a copy command. A cut command removes selected data, such as textual data or other data, from a file of a currently open application window of an application program currently running on the computing device, and moves the selected data to the clipboard. A copy command, by comparison, copies the selected data to the clipboard. That is, a copy of the selected data is moved to the clipboard.

The data in question has a data attribute. As noted above, the attribute may be a data structure, like a particular format, examples of which include phone numbers and part numbers. Another data attribute is a type of the data. The type may be text data, image data, rich-text format (RTF) data, and so on.

The computing device can determine a likely destination at which pasting of the data cut or copied to the clipboard will occur (504). The likely destination can be determined from prior user activity regarding other data having the same attribute as the data that has been cut or copied to the clipboard. As described above in relation to the example usage scenarios of FIGS. 1-4, for instance, the pasting of data having the same attribute by a user may be monitored, as the user pastes data. On the basis of such monitoring, the likely destination can be determined. Such monitoring can further be crowd sourced; that is, the pasting of the data by different users on the same or different computing devices can be monitored to determine the likely destination at which pasting of the data that has been cut or copied will occur. The destination can be an open application window of an application program, an application program more generally, or a file or document that was previously open in an application window but that does not currently correspond to any open application window.

In another implementation, the likely destination can be determined from an analysis of existing destinations that are receptive to the pasting of data having the same data attribute as the data that has been cut or copied to the clipboard. For example, the data may have an attribute as a data format consistent with that of a part number from a particular manufacturer. There may be a limited number of files stored on storage devices accessible by the computing device in which data having the same format is stored. As such, these files, regardless of whether they are word processing documents, spreadsheet documents, or other files, may be considered as likely destinations of the data that has been cut or copied to the clipboard. As another example, of the open application windows, some may have data having the same data format, regardless of whether the data was pasted into the windows, or manually entered by the user using an input device like a keyboard. Therefore, these application windows, regardless of the files or documents to which they correspond, may be considered as likely destinations of the data that has been cut or copied to the clipboard.

The computing device determines an action related to pasting of the data at the likely destination, based on an attribute of the data (506). As has been described in relation to the example usage scenarios of FIGS. 1-4, a number of different actions can be determined. The action can include how open applications or files are presented within a task-switching GUI component of the user interface. The action can include determining and display a list of destinations for pasting of the data. The action can include determining and navigating to a particular location within the source of the data from which the data was cut or copied, different from the location at which the data was cut or copied. The action can include determining and navigating to a different application window, application program, or file or document than that from which the data was cut or copied. The action can include pasting of the data, in addition to any other data pasting-related action.

The computing device may immediately perform the action (510), or may first wait for the performance of interaction by the user within the user interface (508) before performing the action (510). For instance, how open application windows are presented within a task-switching GUI component may not be determined until the user initiates this component via interacting with the user interface, such as by pressing a keyboard shortcut. If the task-switching GUI component is not initiated as the next interaction within the user interface, then the action may not be performed even when this GUI component is later initiated. As another example, a dialog box may be presented asking the user if he or she wishes the action to be performed, where the action is performed just if the user performs the user interface action of selecting “yes” or “OK” on the dialog box. As a third example, a user may have to initiate a keyboard shortcut or another user interface interaction to cause the action to be performed, where such an interaction is not responsive to a dialog box or other GUI component assisting the user in this respect.

The example method 500 of FIG. 5 contemplates that a user may have determined which data attributes will be searched for when data is cut or copied to the clipboard, and/or that the user may have associated the data attributes to a data pasting-related action. However, the techniques disclosed herein can also be employed in such a way as to require minimal or even no effort by the user to specify which data attributes will be searched for when data is cut or copied, and/or to associate data attributes to data pasting-related actions. Rather, as the user performs pasting of data, the action the user performs is logged along with the data attribute of the data, and this information is used to subsequently determine data pasting-related actions and the likely destinations of cut or copied data, based on the attribute of the data that has been cut or copied.

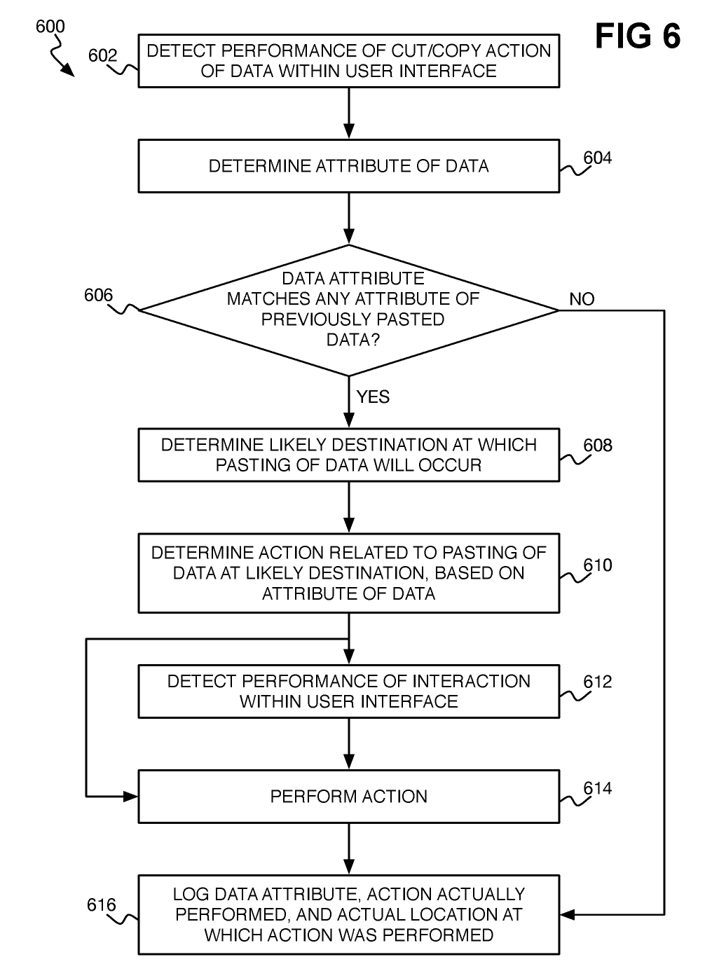

FIG. 6 shows such an example method 500 in which a data pasting-related action is performed based on a data attribute of cut or copied data. The method 600 is consistent with but more detailed than the method 500 of FIG. 5. Like the method 500, the method 600 encompasses the example usage scenarios that have been described in relation to FIGS. 1-4. A computing device performs the method 600.

The computing device detects performance of the cut/copy action within a user interface of the computing device (602), and determines an attribute of this data (604). Part 602 may be performed as has been described above in relation to part 502 of the method 500. Determination of the attribute of the cut or copied data in part 604 can be performed in a number of different ways. For instance, different types of data, such as plain text, RTF, image data, and so on, may be distinguished. As another example, different data formats may additionally or alternatively be distinguished. Machine learning and other techniques may be used, for instance, to compare the data that has been cut or copied to the clipboard to a variety of different existing data formats to attempt to discern the format of the cut or copied data. If no existing data format is discerned, a new data format may be created.

If the data attribute of the data that has been cut or copied matches the attribute of any previously pasted data by the user (or by a community of users, as is the case in a crowd-sourcing technique) (606), then the likely destination at which pasting of the data will occur is determined (608) based on the attribute, as well as a data pasting-related action with respect to the destination (610), again based on the attribute. In this respect, parts 608 and 610 can be performed as has been described above in relation to parts 540 and 506 of the method 500, respectively. Specifically, since the data that has been cut or copied has an attribute that matches an attribute of previously pasted data, there is at least one data pasting-related action and/or destination corresponding to this attribute. Therefore, this information can be used to determine the data pasting-related action and/or likely destination for the cut or copied data that is currently in the clipboard. The greater the number of times the user has pasted data having the same attribute, the greater the accuracy the likely destination and/or data pasting-related action will likely be.

As in the method 500, once the likely destination and the action have been determined, the action can be performed in relation to the destination immediately (614), or after first waiting for and thus detecting performance of another interaction by the user within the user interface (612). In this respect, the method 600 proceeds from part 610 to part 614 directly or to part 614 via part 612 in the same way that the method 500 has been described as proceeding from part 506 to part 510 directly or to part 510 via part 508. For instance, as noted above in relation to the method 500, the action may not be performed in part 614 if the next interaction by the user within the user interface in part 612 is not a particular type of interaction, such as the initiation of a task-switching GUI component.

The method 600 further logs the data attribute of the data that has been cut or copied to the clipboard, the action that has actually been performed, as well as the actual location (i.e., the destination) at which this action was performed (616). The method proceeds to part 616 in two different ways: from part 614 or from part 608. As to the former, the action that is logged in part 616 is that which was automatically performed in part 614 by the computing device. By comparison, as to the latter, the action that is logged in part 616 is that which the user manually performed, as monitored by the computing device. For instance, if the data attribute of the data that was cut or copied to the clipboard does not match any attribute of previously pasted data, then the action (and location) that will be logged is that which the user manually performed. This is also the case if the user overrides the action determined in part 610 and/or the likely destination determined in part 608.

As such, the method 600 permits the computing device to learn over time what the user typically does, and in relation to which destination or location, after cutting or copying data having the same or different attributes to the clipboard. This information is logged, and then is used to determine both the likely destination at which pasting of data will occur, as well as a data pasting-related action that will be performed. Therefore, in the method 600, the user may not have to pre-associate locations and/or data pasting-related actions to different data attributes. Rather, the computing device learns this information by monitoring the user (and potentially other users, in a crowd-sourcing implementation) over time.

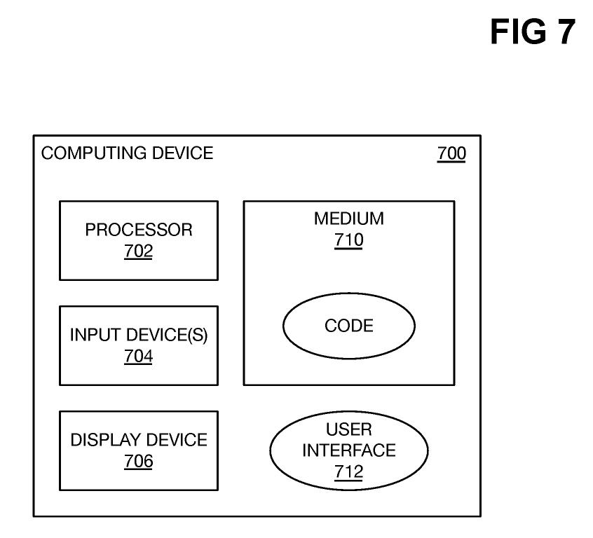

FIG. 7 shows an example computing device 700. The computing device 700 may be a computer, such as a laptop or a desktop computer. The computing device 700 may be a mobile computing device, such as a tablet computing device, a smartphone, and so on. The computing device 700 includes at least a processor 702, one or more input devices 704, a display device 706, and a non-transitory computer-readable medium 708 storing computer-executable code 710. The computing device 700 can include other hardware components, in addition to those depicted in FIG. 7.

The input devices 704 can include a keyboard, as well as a pointing device like a mouse or touchpad. The display device 706 can be a flat-panel display, or another type of display device. The computer-readable medium 708 may be or include a non-volatile medium such as a hard disk drive or flash storage device, as well as a volatile medium such as dynamic random-access memory. The processor 702 executes the computer-executable code 710 stored on the computer-readable medium 708.

By executing the computer-executable code 710, the processor 702 realizes a user interface 712, such as a GUI. The processor 702 further by executing the code 710 can perform any of the methods that have been described above. The methods are thus performed in relation to the user interface 712, with which the user interacts via the input devices 704.

The techniques that have been disclosed improve cut/copy-and-paste user interface techniques. Specifically, based on an attribute of data that a user has cut or copied to the clipboard, a data pasting-related action is performed. This is particularly beneficial when a user is copying or cutting many pieces of data that have the same attribute, and then wishes to perform the same action in relation to each piece of data.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Examples of non-transitory computer-readable media include both volatile such media, like volatile semiconductor memories, as well as non-volatile such media, like non-volatile semiconductor memories and magnetic storage devices. It is manifestly intended that this invention be limited only by the claims and equivalents thereof.

We claim:

1. A method comprising:
detecting, by a computing device, performance of a cut/copy action of data within a user interface of the computing device;
in response to detecting the performance of the cut/copy action, determining, by the computing device, an action related to pasting of the data, based on an attribute of the data; and
performing the action, by the computing device.

2. The method of claim 1, wherein the action is performed after the action has been determined, without waiting for further interaction within the user interface.

3. The method of claim 1, further comprising:
detecting, by the computing device, performance of interaction within the user interface,
wherein the action is performed in response in response to detecting the performance of the interaction within the user interface.

4. The method of claim 1, wherein the attribute of the data on which basis the action related to pasting of the data is determined comprises:
a type or data structure of the data.

5. The method of claim 1, wherein determining the action related to the pasting of the data comprises:
changing how open applications or files are presented within a task-switching graphical user interface (GUI) component of the user interface, based on likelihoods of the applications or files being an intended destination of the pasting of the data.

6. The method of claim 1, wherein determining the action related to the pasting of the data comprises:
determining and displaying a list of destinations for the pasting of the data, based on likelihoods of the destinations being an intended destination of the pasting of the data.

7. The method of claim 1, wherein determining the action related to the pasting of the data comprises:
determining and navigating to a particular location within a source of the data that was subject to the performance of the cut/copy action, the particular location being a proposed destination of the pasting of the data and different from a location at which the data was cut or copied.

8. The method of claim 1, wherein determining the action related to the pasting of the data comprises:
determining and navigating to a different destination for the pasting of the data.

9. The method of claim 1, wherein determining the action related to the pasting of the data further comprises:
determining a likely destination at which the pasting of the data will occur.

10. The method of claim 9, wherein determining the likely destination comprises:
determining the likely destination from prior user activity as to data having the attribute of the data that was subject to the performance of the copy action.

11. The method of claim 9, wherein determining the likely destination comprises:
determining the likely destination from analysis of existing destinations that are receptive to pasting of data having the attribute of the data that was subject to the performance of the copy action.

12. A non-transitory computer-readable data storage medium storing computer-executable code that a computing device executes to:
detect performance of a cut/copy action of data within a user interface of the computing device;
in response to detecting the performance of the cut/copy action, determine:
a likely destination at which pasting of the data will occur, based on an attribute of the data;
an action related to the pasting of the data at the likely destination, based on the attribute of the data; and
perform the action.

13. The non-transitory computer-readable data storage medium of claim 12, wherein the likely destination comprises a plurality of open applications or files on the computing device,
and wherein the action is changing how the open applications or files are presented within a task-switching graphical user interface (GUI) component of the user interface, based on likelihoods of the applications or files being an intended destination of the pasting of the data.

14. The non-transitory computer-readable data storage medium of claim 12, wherein the likely destination comprises a plurality of destinations,
and wherein the action is displaying a list of the destinations for the pasting of the data, based on likelihoods of the destinations being an intended destination of the pasting of the data.

15. The non-transitory computer-readable data storage medium of claim 12, wherein the likely destination is a particular location within a source of the data that was subject to the performance of the cut/copy action, the particular location different from a location at which the data was cut or copied,
and wherein the action is navigating to the particular location within the source of the data.

16. The non-transitory computer-readable data storage medium of claim 12, wherein the action is navigating to the likely destination for the pasting of the data.

17. A computing device comprising:
a processor;
a non-transitory computer-readable data storage medium storing computer-executable code that the processor executes to:
detect that a cut/copy action of data has occurred within a user interface of the computing device;
in response to detecting the performance of the cut/copy action, determine:
a likely destination at which pasting of the data will occur, based on an attribute of the data;
an action related to the pasting of the data at the likely destination, based on the attribute of the data; and
perform the action.

18. The computing device of claim 17, wherein the likely destination comprises a plurality of open applications or files on the computing device,
and wherein the action is changing presentation of the open applications or files within a task-switching graphical user interface (GUI) component of the user interface, based on likelihoods of the applications or files being an intended destination of the pasting of the data.

19. The computing device of claim 17, wherein the likely destination comprises a plurality of destinations,
and wherein the action is displaying the destinations for the pasting of the data, based on likelihoods of the destinations being an intended destination of the pasting of the data.

20. The computing device of claim 17, wherein the likely destination is a particular location within a source of the data that was subject to the performance of the cut/copy action, the particular location different from a location at which the data was cut or copied,
and wherein the action is navigating to the particular location within the source of the data.

21. The computing device of claim 17, wherein the action is navigating to the likely destination for the pasting of the data.
